(19) United States
(12) Patent Application Publication
(10) Pub. No.: US 2023/0037181 A1
(43) Pub. Date: Feb. 2, 2023

(54) POLYCRYSTALLINE CUBIC BORON NITRIDE MATERIAL

(71) Applicant: Element Six (UK) Limited, Oxfordshire (GB)

(72) Inventors: Antionette CAN, Oxfordshire (GB); Xiaoxue ZHANG, Oxfordshire (GB); Volodymyr BUSHLYA, Lund (SE); Filip Ernst LENRICK, Kävlinge (SE); Jan-Eric STÅHL, Lund (SE); Denis STRATIICHUK, Kiev (UA); Igor PETRUSHA, Kiev (UA); Vladimir TURKEVICH, Kiev (UA)

(21) Appl. No.: 17/789,417

(22) PCT Filed: Jan. 28, 2021
(86) PCT No.: PCT/EP2021/052018

§ 371 Date: Jun. 27, 2022

(30) Foreign Application Priority Data
Jan. 28, 2020 (GB) 2001174.8

(51) Int. Cl. C04B 35/5831; C04B 35/626; C04B 35/645; B23C 5/16; C22C 26/00; C22C 1/05

(52) U.S. Cl. CPC C04B 35/5831; B23C 5/16; C04B 35/645; C04B 35/6261; C22C 1/051; C22C 26/00; C04B 2235/386; C04B 2235/656; C04B 2235/3217; C04B 2235/3869; C04B 2235/3886; C22C 2026/003; C22C 2026/007; C22C 2026/008

(57) ABSTRACT

This disclosure relates to a polycrystalline cubic boron nitride, PCBN, material that includes a binder matrix material containing nitride compounds. The nitride compounds are selected from HfN, VN, and/or NbN.

### FIELD OF THE INVENTION

This disclosure relates to the field of sintered polycrystalline cubic boron nitride materials, and to methods of making such materials. In particular, this disclosure relates to the machining of the Inconel™ family of super-alloys using sintered polycrystalline cubic boron nitride materials.

### BACKGROUND

Polycrystalline super-hard materials, such as polycrystalline diamond (PCD) and polycrystalline cubic boron nitride (PCBN) may be used in a wide variety of tools for cutting, machining, drilling or degrading hard or abrasive materials such as rock, metal, ceramics, composites and wood-containing materials.

Abrasive compacts are used extensively in cutting, turning, milling, grinding, drilling and other abrasive operations. They generally contain ultrahard abrasive particles dispersed in a second phase matrix. The matrix may be metallic or ceramic or a cermet. The ultrahard abrasive particles may be diamond, cubic boron nitride (cBN), silicon carbide or silicon nitride and the like. These particles may be bonded to each other during the high pressure and high temperature compact manufacturing process generally used, forming a polycrystalline mass, or may be bonded via the matrix of second phase material(s) to form a sintered polycrystalline body. Such bodies are generally known as polycrystalline diamond or polycrystalline cubic boron nitride, where they contain diamond or cBN as the ultra-hard abrasive, respectively.

U.S. Pat No 4,334,928 teaches a sintered compact for use in a tool consisting essentially of 20 to 80 vol.% of cubic boron nitride; and the balance being a matrix of at least one matrix compound material selected from the group consisting of a carbide, a nitride, a carbonitride, a boride and a silicide of a IVa or a Va transition metal of the periodic table, mixtures thereof and their solid solution compounds. The methods outlined in this patent all involve combining the desired materials using mechanical milling/mixing techniques such as ball milling, mortars and the like.

Sintered polycrystalline bodies may be ‘backed’ by forming them on a substrate. Cemented tungsten carbide, which may be used to form a suitable substrate, is formed from carbide particles dispersed, for example, in a cobalt matrix by mixing tungsten carbide particles/grains and cobalt together then heating to solidify. To form the cutting element with an ultra-hard material layer such as PCD or PCBN, diamond particles or grains or CBN grains are placed adjacent the cemented tungsten carbide body in a refractory metal enclosure such as a niobium enclosure and are subjected to high pressure and high temperature so that inter-grain bonding between the diamond grains or CBN grains occurs, forming a polycrystalline super hard diamond or polycrystalline CBN layer.

In some instances, the substrate may be fully sintered prior to attachment to the ultra-hard material layer whereas in other cases, the substrate may be green (not fully sintered). In the latter case, the substrate may fully sinter during the HPHT sintering process. The substrate may be in powder form and may solidify during the sintering process used to sinter the ultra-hard material layer.

Alternatively, solid sintered polycrystalline bodies may be unbacked, and formed to be freestanding without a substrate.

FIG. 1 shows an exemplary method for producing a sintered PCBN material. The following numbering corresponds to that of FIG. 1:
S1. Matrix precursor powders are pre-mixed. Examples of matrix precursor powders include carbides and/or nitrides of titanium and aluminium. Typical average particle sizes for the matrix precursor powders are between 1 µm and 10 µm.
S2. The matrix precursor powders are heat treated at over 1000° C. for at least an hour to initiate a pre-reaction between the matrix precursor particles and to form a “cake”.
S3. The cake is crushed and sieved to obtain the desired size fraction of particles.
S4. Cubic boron nitride (cBN) particles with an average particle size of 0.5 µm to 15 µm are added to the sieved matrix precursor powders.
S5. The resultant mixed powders are ball milled to break down the matrix precursor powders to a desired size (typically 50 nm to 700 nm) and to intimately mix the matrix precursor powders with the cBN particles. This process may take many hours, and involves using milling media such as tungsten carbide balls.
S6. The resultant milled powder is dried under vacuum or low pressure at above 60° C. to remove solvent, and subsequently conditioned by slowly allowing oxygen into the system to passivate metallic surfaces such as aluminium.
S7. The dried powder is sieved and a pre-composite assembly is prepared.
S8. The pre-composite assembly is heat treated at above 700° C. to remove any adsorbed water or gases.
S9. The outgassed pre-composite assembly is assembled into a capsule suitable for sintering.
S10. The capsule is sintered in a high pressure high temperature (HPHT) process of at least 1250° C. and at least 4 GPa to form a sintered PCBN material.

Both tungsten (W) and cobalt (Co) have been classed in Europe as a Critical Raw Material (CRM). CRMs are raw materials deemed economically and strategically important for the European economy. In principal, they have a high-risk associated with their supply, have a significant importance for key sectors in the European economy such as consumer electronics, environmental technologies, automotive, aerospace, defence, health and steel, and they have a lack of (viable) substitutes. Both tungsten and cobalt are main constituents for two important classes of hard materials, cemented carbides/WC-Co, and PCD/diamond-Co.

### SUMMARY OF THE INVENTION

It is an aim of this invention to develop viable alternative materials for tooling operations that perform well under extreme conditions, and that do not required the use of a WC-Co backing.

According to a first aspect of the invention, there is provided a polycrystalline cubic boron nitride, PCBN, material comprising:
between 40 and 95 vol.% cubic boron nitride, cBN, particles,
a binder matrix material in which the cBN particles are dispersed, the content of the binder matrix material being between 5 vol.% and 60 vol.% of the PCBN material,
the binder matrix material comprising aluminium or a compound thereof, and/or titanium or a compound thereof, and
the binder matrix material further comprising oxide compounds, nitride compounds and/or oxynitride compounds, wherein the nitride compounds are selected are any one or more of the following: HfN, VN, and/or NbN.

Optionally, said oxynitride compound is present in an amount of between 5 vol.% and 35 vol.% of the PCBN material.

Optionally, said oxynitride compound is present in an amount of between 10 vol.% and 25 vol.% of the PCBN material.

Optionally, said oxynitride compound comprises AlON.

Optionally, said oxide compound comprises Al₂O₃. The Al₂O₃ may be present in an amount of 10 vol.% or 25 vol% of the PCBN material.

Optionally, said HfN is present in an amount of 10 vol.% or 25 vol% of the PCBN material. The binder matrix material may further comprise HfB₂ and/or BN.

Optionally, said VN is present in an amount of 10 vol.% or 25 vol% of the PCBN material. The binder matrix material may further comprise AlN and/or BN.

Optionally, said NbN is present in an amount of 10 vol.% or 25 vol% of the PCBN material.

Optionally, said aluminium, Al, or a compound thereof, is present in amount of between 2 and 15 vol.%, preferably 5 and 15 vol.%, and more preferably 5 vol.% of the PCBN material.

The PCBN material may comprise 50 to 70 vol.% cubic boron nitride, cBN. Optionally, the PCBN material comprises 60 vol.% cubic boron nitride, cBN.

According to a second aspect of the invention, there is provided a method of making a polycrystalline cubic boron nitride, PCBN, material, the method comprising:
milling together precursor powders of :
   cubic boron nitride, cBN, powder
   oxide-containing powder
   nitride-containing powder, wherein the nitride-containing powders are selected from: HfN, VN, and/or NbN,
   aluminium-containing powder and/or titanium-containing powder
compacting the milled precursor powders to form a green body;
sintering the green body at a temperature between 1250° C. and 2200° C. at a pressure of between 4.0 GPa and 8.5 GPa to form the sintered PCBN material in accordance with the first aspect of the invention.

Optionally, the oxide-containing powders comprise Al₂O₃.

Optionally, the temperature is between 1250° C. and 1450° C.

Optionally, the temperature is 1350° C.

Optionally, the pressure is around 6.5 GPa.

Optionally, the temperature is between 1800° C. and 2100° C.

Optionally, the pressure is around 8 GPa.

According to a third aspect of the invention, there is provided use of PCBN material in accordance with the first aspect of the invention, for machining heat resistant superalloys. Such heat resistant superalloys may include Inconel™, a family of austenitic nickel-chromium-based superalloys.

### BRIEF DESCIPTION OF THE DRAWINGS

Non-limiting embodiments will now be described by way of example and with reference to the accompanying drawings in which:

FIG. 1 is a flow diagram showing a known exemplary method of making a sintered PCBN material;

FIG. 2 is a flow diagram showing an embodiment of a process used to make a PcBN material in accordance with the invention;

FIG. 3 is an X-ray Powder Diffraction (XRD) pattern of sintered Example 1 produced using Powder 1, which contains HfN and Al₂O₃, sintered at 6.5 GPa;

FIG. 4 indicates a Scanning Electron Microscopy (SEM) micrograph of Example 1, at magnification X2000;

FIG. 5 are Energy Dispersive X-ray Spectroscopy (EDS) images of Example 1;

FIG. 6 is an XRD pattern of sintered Example 2 produced using Powder 2, which contains VN and Al₂O₃, sintered under 6.5 GPa conditions;

FIG. 7 is an SEM micrograph of Example 2, at magnification X2000;

FIG. 8 are EDS images of Example 2;

FIG. 9 is an XRD pattern of sintered Example 3 produced using Powder 2, which contains VN, under 8.4 GPa condition;

FIG. 10 is an image of an example indentation in a PCBN material indicating the measurements used in calculating the hardness;

FIG. 11 is a line chart showing the performance in profile operation of aged Inconel™ 718 (HRC 44 - 46) ofHPHT sintered samples with different binder chemistries;

FIG. 12 is a bar chart showing the performance in longitudinal machining of aged Inconel™ 718 (HRC 44 - 46) ofHPHT and LPLT sintered samples with VN and Al₂O₃ binder chemistry;

FIG. 13 is an optical image showing the wear scar of reference PCBN material with TiC binder from FIG. 12;

FIG. 14 is an optical image showing the wear scar of the PCBN material with Al₂O₃-VN binder sintered at HPHT conditions from FIG. 12; and

FIG. 15 is an optical image showing the wear scar of the PCBN material with Al₂O₃-VN binder sintered at LPLT conditions from FIG. 12.

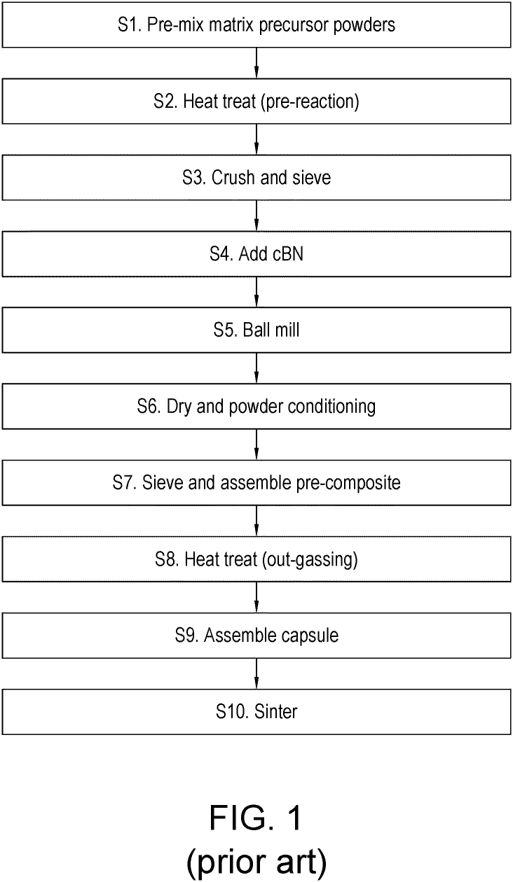

### DETAILED DESCRIPTION

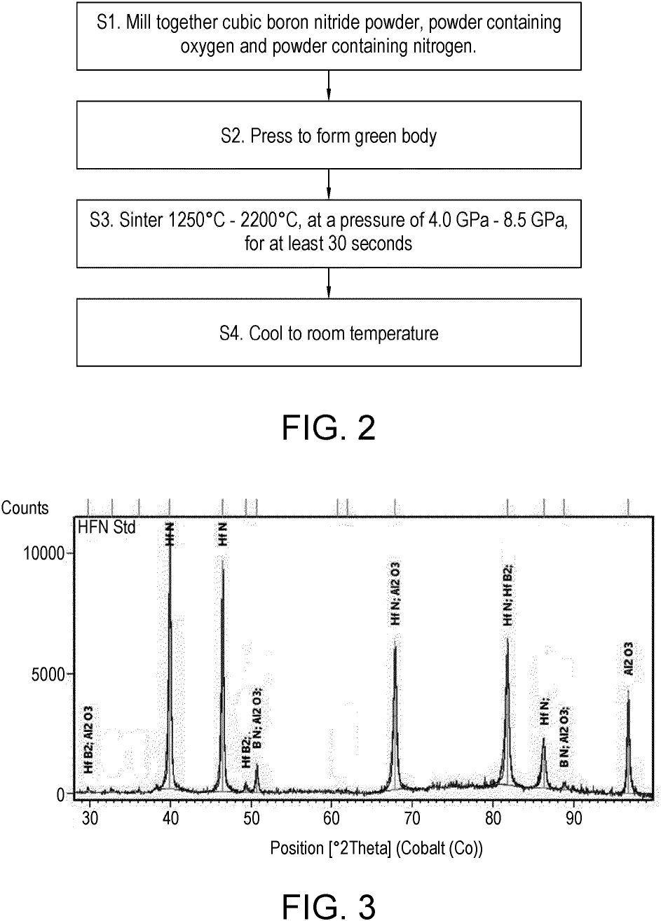

FIG. 2 is a flow diagram showing exemplary steps, in which the following numbering corresponds to that of FIG. 2.

S1. Precursor powders are milled together to form an intimate mixture and obtain a desired particle size. The precursor powders comprise oxide-containing powder, nitride-containing powder, aluminium powder and cBN powders. The precursor powder mixing was carried out in organic solvent using ball-milling techniques and drying with a rotary evaporator.

S2. The milled precursor powders are dry pressed together to form a green body in metal encapsulation before putting it into a HPHT capsule. In the case of HPHT sintering, Specifically, after drying, the powder is filled into a soft mould, then compressed using a Cold Isostatic Press to compact the powder and form the green body with high green density in order to have less dimensional change after sintering.

The green body is then cut into different heights to fit into a HPHT capsule. S3. The dry pressed green body is then subjected to high temperature vacuum heat treatment and subsequently sintered in a capsule.

Materials generated thus far were sintered under two conditions:
a pressure of around 6.5 GPa and at a temperature between 1250° C. and 1450° C., and typically at 1350° C.; and
a pressure of around 8 GPa and at a temperature between 1800° C. and 2100° C.

The sintering temperature was calibrated up to 1800° C. using S-type thermocouples.

S4. After sintering, the resultant sintered articles cool to room temperature. The cooling rate is uncontrolled.

### EXAMPLES

Table 1 lists all the PcBN compositions that were included in this work, together with a TiC and a TiCN reference sample. In this section, LPLT stands for Lower Pressure and Lower Temperatures, and HPHT stands for Higher Pressure and Higher Temperatures.

Table 1

| Powder 1 Al₂O₃-HfN binder | Sintering Conditions | cBN (vol %) | Al₂O₃ (vol %) | HfN (vol %) | Al (vol %) |
|---|---|---|---|---|---|
| | LPHT (Example 1) | 60 | 10 | 25 | 5 |
| Powder 2 Al₂O₃-VN binder | Sintering Conditions | cBN (vol %) | Al₂O₃ (vol %) | VN (vol %) | Al (vol %) |
| | LPLT (Example 2) & HPHT (Example 3) | 60 | 25 | 10 | 5 |
| Powder 3 Al₂O₃-NbN binder | Sintering Conditions | cBN (vol %) | Al₂O₃ (vol %) | NbN (vol %) | Al (vol %) |
| | HPHT | 60 | 25 | 10 | 5 |
| Reference 1 TiC binder | Sintering Conditions | cBN (vol %) | TiC (vol %) | | Al (vol %) |
| | HPHT | 60 | 35 | | 5 |
| Reference 2 TiCN binder | Sintering Conditions | cBN (vol %) | TiCN (vol %) | | Al (vol %) |
| | HPHT | 60 | 35 | | 5 |

Examples 1, 2 and 3 are described in more detail below. Other samples provided in Table 1, both inventive and reference, were prepared, characterised and subsequently tested in a similar way to Examples 1, 2 and 3.

### Example 1

S1. Precursor powders comprising Al₂O₃ and HfN were mixed together with cBN powders and Al powder, in the proportions provided in Table 1, as per the description above.

S2. The precursor powders were then compacted to form a green body inside metal encapsulation.

S3. The green body was placed inside a capsule, and then sintered.

S4. The sintered article, PCBN material, was cooled to room temperature, ready for subsequent characterisation and application testing.

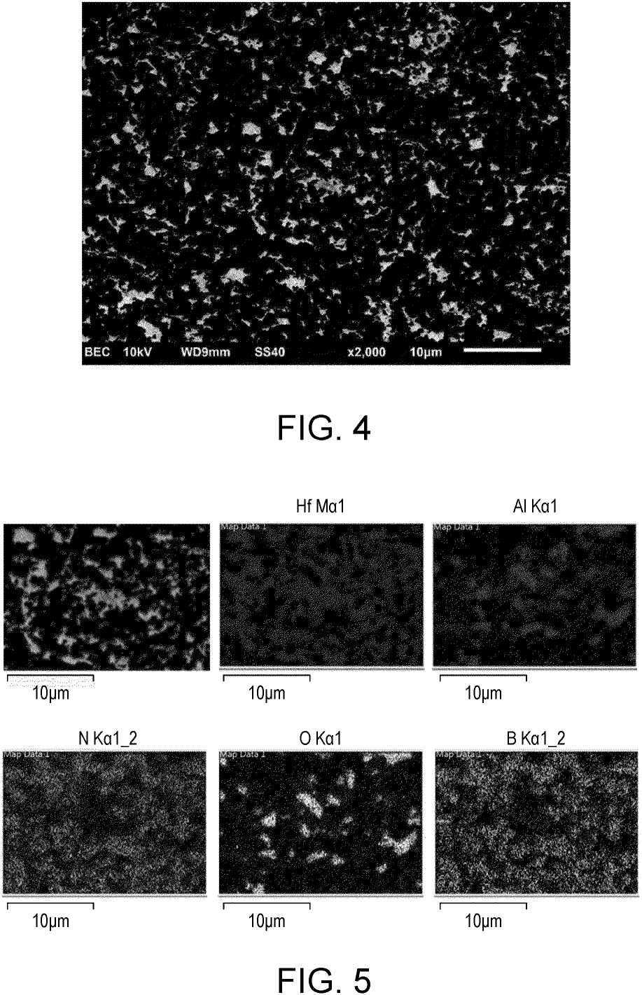

The XRD trace is provided in FIG. 3 and indicates the presence ofHfN, HfB₂, Al₂O₃ and BN in the sintered article. FIG. 4 conveys the resulting microstructure and the EDS images in FIG. 5 provide a breakdown of the composition of the microstructure in select areas of the sample.

### Example 2

S1. Precursor powders comprising Al₂O₃ and VN were mixed together with cBN powders, in the proportions provided in Table 1, as per the description above.

S2. The precursor powders were then compacted to form a green body inside metal encapsulation.

S3. The green body was placed inside a capsule, and then LPLT sintered.

S4. The sintered article, PCBN material, was cooled to room temperature, ready for subsequent characterisation and application testing.

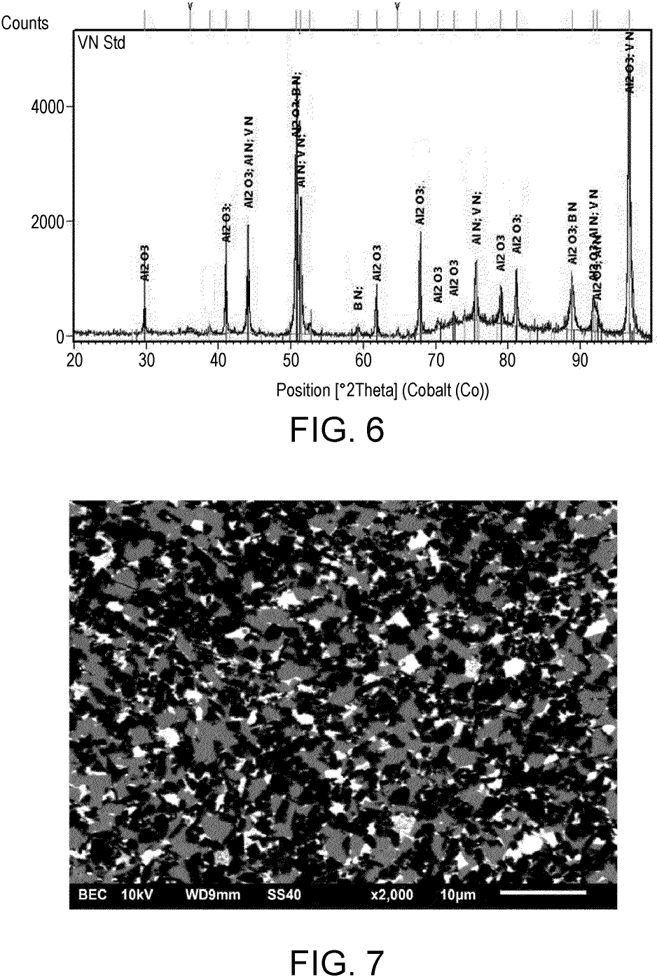

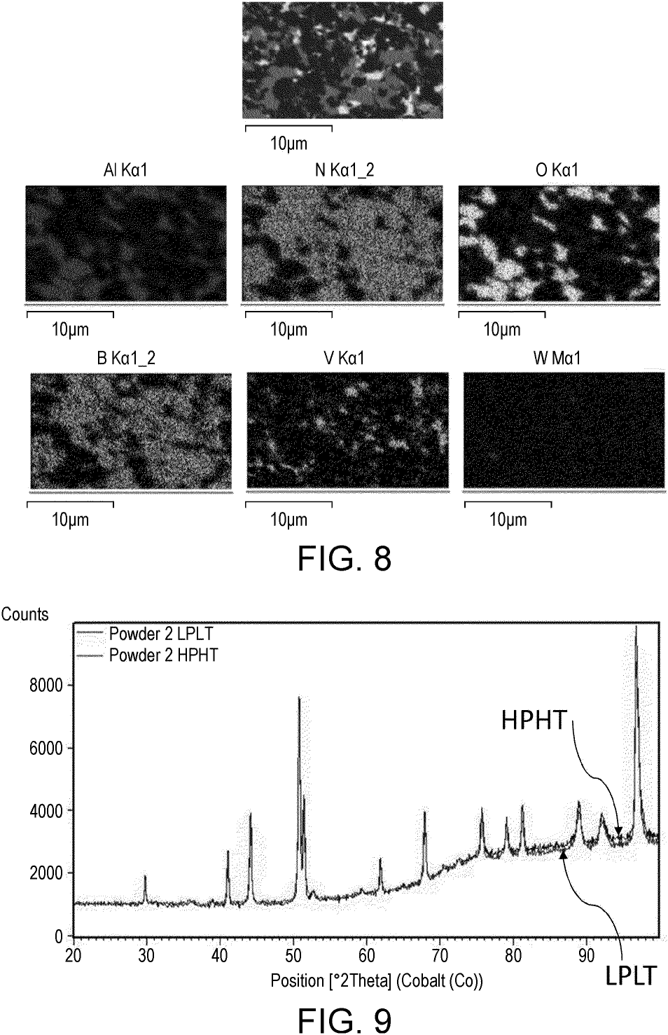

The XRD trace is provided in FIG. 6 and indicates the presence ofVN, AlN, Al₂O₃ and BN in the sintered article. FIG. 7 conveys the resulting microstructure and the EDS images in FIG. 8 provide a breakdown of the composition of the microstructure in select areas of the sample.

### Example 3

S1. Precursor powders comprising Al₂O₃ and VN were mixed together with cBN powders, in the proportions provided in Table 1, as per the description above.

S2. The precursor powders were then compacted to form a green body.

S3. The green body was cut to size, placed inside a capsule, and then HPHT sintered.

S4. The sintered article, PCBN material, cooled to room temperature, ready for subsequent characterisation and application testing.

The XRD trace is provided in FIG. 9 and indicates the presence ofVN, AlN, Al₂O₃ and BN in the sintered article. SEM micrographs and EDS images of the sample were taken but are not included here.

### Hardness

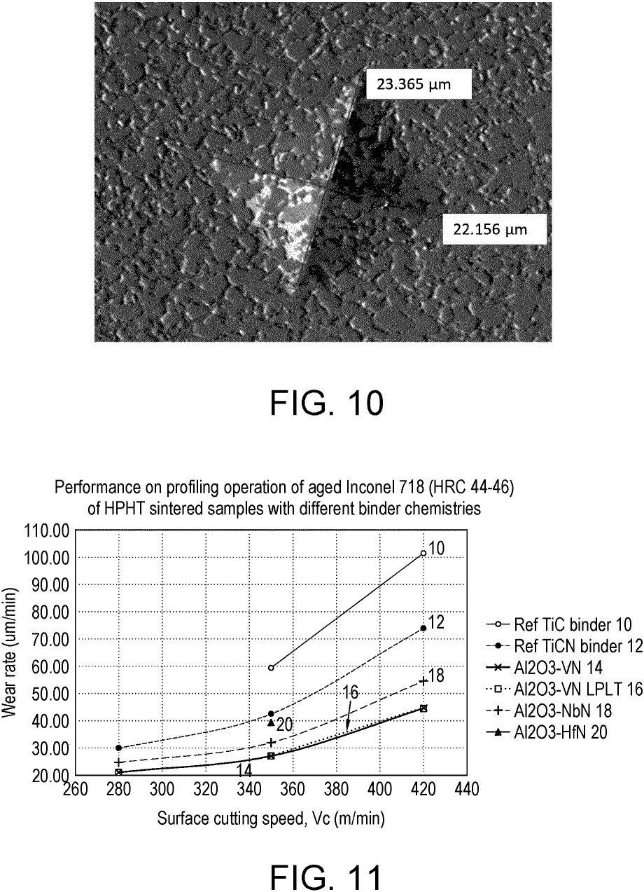

The samples were further characterised using the Vickers hardness test. The Vickers Hardness (HV) is calculated by measuring the diagonal lengths (e.g. see FIG. 10) of an indent in the sample material left by introducing a diamond pyramid indenter with a given load.

Table 2 indicates the hardness of samples sintered from powder 1 and 2 in different conditions.

Table 2

| | | |
|---|---|---|
| | HPHT condition | LPLT condition |
| Powder 1 (Al2O3-HfN binder) | n/a | 35.44 GPa |
| Powder 2 (Al2O3-VN binder) | 34.33 GPa | 32.08 GPa |

The results show that all samples have a relatively high hardness, but moreover that sintering at higher pressures and temperatures increases the hardness only slightly.

### Applications Testing

The PCBN variants with different binder chemistries were then tested in profiling aged Inconel™ 718, which has a Rockwell Hardness of HRC 44 - 46. The results are shown in FIG. 11. FIG. 11 is a graph plotting surface cutting speed v_{c} in m/min, with wear rate, in µm/min. The wear rate was measured at three different surface cutting speeds, for most samples. These surface cutting speeds were 280 m/min, 350 m/min and 420 m/min.

The reference TiC binder is indicated generally at 10 and the TiCN binder at 12. Al₂O₃-VN (HPHT) has reference 14. Al₂O₃-VN (LPLT) has reference 16. Al₂O₃-NbN (HPHT) has reference 18. Al₂O₃-HfN (HPHT) has reference 20 and comprises a single data point.

From FIG. 11, it is clear that all samples from Table 1 perform better than the reference samples.

Also, referring to the samples with reference 14 and 16 (i.e. with binder chemistry Al₂O₃-VN) on the graph, there is marginal difference in wear rate when sintering under LPLT conditions compared to sintering under HPHT conditions.

Al₂O₃-VN (whether HPHT or LPLT) performs better than any of the samples. Al₂O₃-NbN performs second best, followed by Al₂O₃-HfN.

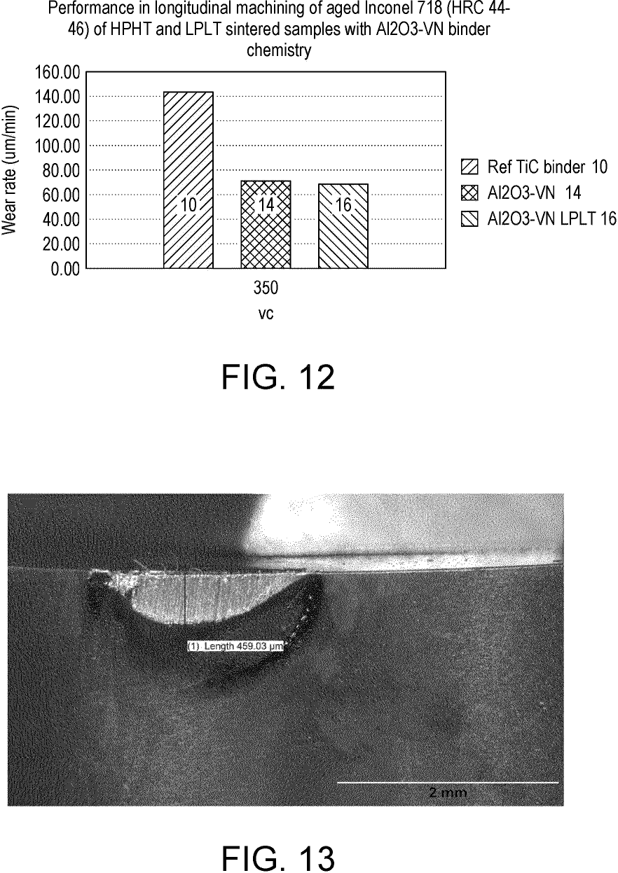

Turning now to FIG. 12, a second application test, similar to the first, was carried out. The second test focused on the performance of the Al₂O₃-VN binder chemistry in longitudinal machining of aged Inconel™ 718, with a Rockwell Hardness ofHRC 44 - 46. Both LPLT and HPHT variants were considered.

FIG. 12 is a bar chart plotting surface cutting speed v_{c}, in m/min, with wear rate, in µm/min. A single surface cutting speed was used, 350 m/min. The results showed that both LPLT and HPHT variants performed significantly better than the reference TiC binder chemistry. Furthermore, that there was minimal difference in wear rate performance between the LPLT and the HPHT variants.

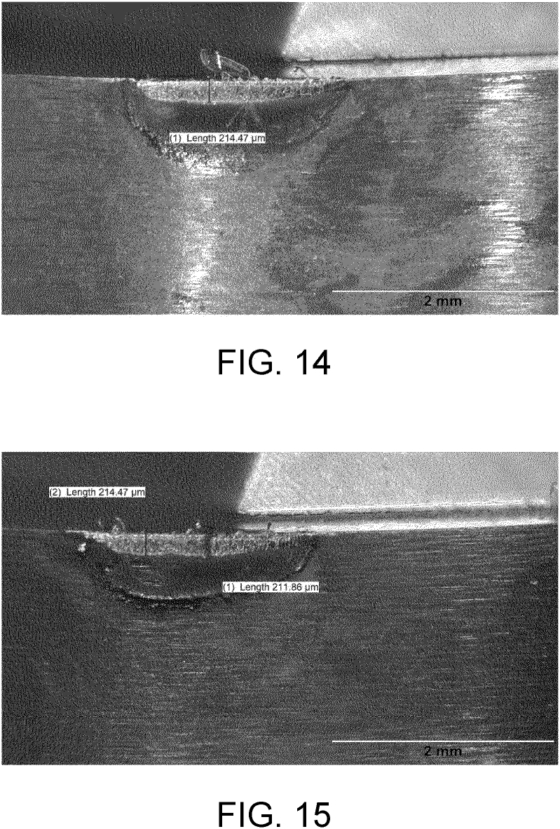

FIGS. 13 to 15 indicate the resulting wear scars. The wear scars for the LPLT and HPHT Al₂O₃-VN binder chemistries are significantly smaller than for the TiC reference sample.

In summary, the inventors have successfully identified several materials which are suitable for use in extreme tooling applications and are viable alternatives to CRMs. In particular, the PCBN materials are especially suitable for machining Inconel™ 718 and offer many advantages over cemented carbide solutions.

### Definitions

As used herein, “PCBN” material refers to a type of super hard material comprising grains of cBN dispersed within a matrix comprising metal or ceramic. PCBN is an example of a super hard material.

As used herein, a “binder matrix material” is understood to mean a matrix material that wholly or partially fills pores, interstices or interstitial regions within a polycrystalline structure.

The term “binder matrix precursor powders” is used to refer to the powders that, when subjected to a HPHT or LPLT sintering process, become the matrix material.

While this invention has been particularly shown and described with reference to embodiments, it will be understood by those skilled in the art that various changes in form and detail may be made without departing from the scope of the invention as defined by the appended claims.

1. A polycrystalline cubic boron nitride, PCBN, material comprising:
between 40 and 95 vol.% cubic boron nitride, cBN, particles,
a binder matrix material in which the cBN particles are dispersed, the content of the binder matrix material being between 5 vol.% and 60 vol.% of the PCBN material,
the binder matrix material comprising aluminium or a compound thereof, and/or titanium or a compound thereof, and
the binder matrix material further comprising oxide compounds, nitride compounds and/or oxynitride compounds, wherein the nitride compounds are selected from: HfN, VN, NbN.

2. The PCBN material as claimed in claim 1, wherein said oxynitride compound is present in an amount of between 5 vol.% and 35 vol.% of the PCBN material.

3. The PCBN material as claimed in claim 2, wherein said oxynitride compound is present in an amount of between 10 vol.% and 25 vol.% of the PCBN material.

4. The PCBN material as claimed in claim 1, wherein said oxynitride compound comprises AlON.

5. The PCBN material as claimed in claim 1, wherein said oxide compound comprises Al₂O₃.

6. The PCBN material as claimed in claim 5, wherein the Al₂O₃ is present in an amount of 10 vol.% or 25 vol.% of the PCBN material.

7. The PCBN material as claimed in claim 1, wherein said HfN is present in an amount of 10 vol.% or 25 vol.% of the PCBN material.

8. The PCBN material as claimed in claim 7, the binder matrix material further comprising HfB₂ and/or BN.

9. The PCBN material as claimed in claim 1, wherein said VN is present in an amount of 10 vol.% or 25 vol.% of the PCBN material.

10. The PCBN material as claimed in claim 9, the binder matrix material further comprising AIN and/or BN.

11. The PCBN material as claimed in claim 1, wherein said NbN is present in an amount of 10 vol.% or 25 vol.% of the PCBN material.

12. The PCBN material as claimed in claim 1, wherein said aluminium, Al, or a compound thereof, is present in amount of between 2 and 15 vol. % of the PCBN material.

13. The PCBN material as claimed in claim 1, comprising 50 to 70 vol.% cubic boron nitride, cBN.

14. The PCBN material as claimed in claim 1, comprising 60 vol.% cubic boron nitride, cBN.

15. A method of making a polycrystalline cubic boron nitride, PCBN, material, the method comprising:
milling together precursor powders of:
cubic boron nitride, cBN, powder,
oxide-containing powder,
nitride-containing powder, wherein the nitride-containing powders are selected from: HfN, VN, and/or NbN,
aluminium-containing powder and/or titanium-containing powder,
compacting the milled precursor powders to form a green body;
sintering the green body at a temperature between 1250° C. and 2200° C. at a pressure of between 4.0 GPa and 8.5 GPa to form the sintered PCBN material of claim 1.

16. The method as claimed in claim 15, wherein the oxide-containing powders comprise Al₂O₃.

17. The method as claimed in claim 15, wherein the temperature is between 1250° C. and 1450° C.

18. The method as claimed in claim 17, wherein the temperature is 1350° C.

19. The method as claimed in claim 17, wherein the pressure is around 6.5 GPa.

20. The method as claimed in claim 15, wherein the temperature is between 1800° C. and 2100° C.

21. The method as claimed in claim 20, wherein the pressure is around 8 GPa.

22. A method of using the PCBN material as claimed in claim 1, the method comprising machining Heat Resistant Superalloys (HRSAs) using the PCBN material.
